(19) United States
(12) Patent Application Publication
(10) Pub. No.: US 2015/0008995 A1
(43) Pub. Date: Jan. 8, 2015

(54) Guiding Medium

(71) Applicant: Roke Manor Research Limited, Romsey (GB)

(72) Inventors: Michael Jessup, Romsey (GB); Janice Turner, Romsey (GB)

(21) Appl. No.: 14/321,950

(22) Filed: Jul. 2, 2014

(30) Foreign Application Priority Data
Jul. 2, 2013 (GB) 1311868.2

(51) Int. Cl. H01P 3/10

(52) U.S. Cl. CPC H01P 3/16
USPC 333/240

(57) ABSTRACT

A guiding medium for guiding radio frequency (RF) electromagnetic surface waves, comprising: a first surface, the first surface having an electrical impedance suitable for the propagation of electromagnetic surface waves; and a protection layer positioned on or adjacent the first surface.

The present invention relates to a guiding medium. In particular, the present invention relates to a guiding medium for guiding electromagnetic surface waves.

### BACKGROUND

The applicant's prior published patent application GB 2,494,435 A discloses a communication system which utilises a guiding medium which is suitable for sustaining electromagnetic surface waves. The contents of GB 2,494,435 A are hereby incorporated by reference. The present application presents various applications and improvements to the system disclosed in GB 2,494,435 A.

### BRIEF SUMMARY

In a first aspect, the present invention provides a guiding medium for guiding radio frequency (RF) electromagnetic surface waves, comprising: a first surface, the first surface having an electrical impedance suitable for the propagation of electromagnetic surface waves; and a protection layer positioned on or adjacent the first surface.

In a second aspect, the present invention provides a system for the transmission of RF electromagnetic surface waves, the apparatus comprising: a guiding medium according to any preceding claim; and at least one wave coupling node, the node having a transmitter and/or receiver coupled to a transducer, the transducer positioned on or adjacent to a surface of the protection layer distal the first surface of the guiding medium; wherein the at least one wave coupling node is arranged to launch and/or receive surface waves over the first surface of said guiding medium.

Further examples of features of embodiments of the present invention are recited in the appended claims.

### DESCRIPTION OF THE DRAWINGS

Embodiments of the present invention will now be described, by way of example only, and with reference to the accompanying drawings, in which:

FIG. 1 shows a guiding medium in accordance with a first embodiment of the present invention;

FIG. 2 shows a test apparatus used to characterise the effect of various thicknesses of protection layer of the guiding medium shown in FIG. 1 on transmission losses; and

FIG. 3 shows a guiding medium in accordance with a further embodiment of the present invention.

### DETAILED DESCRIPTION

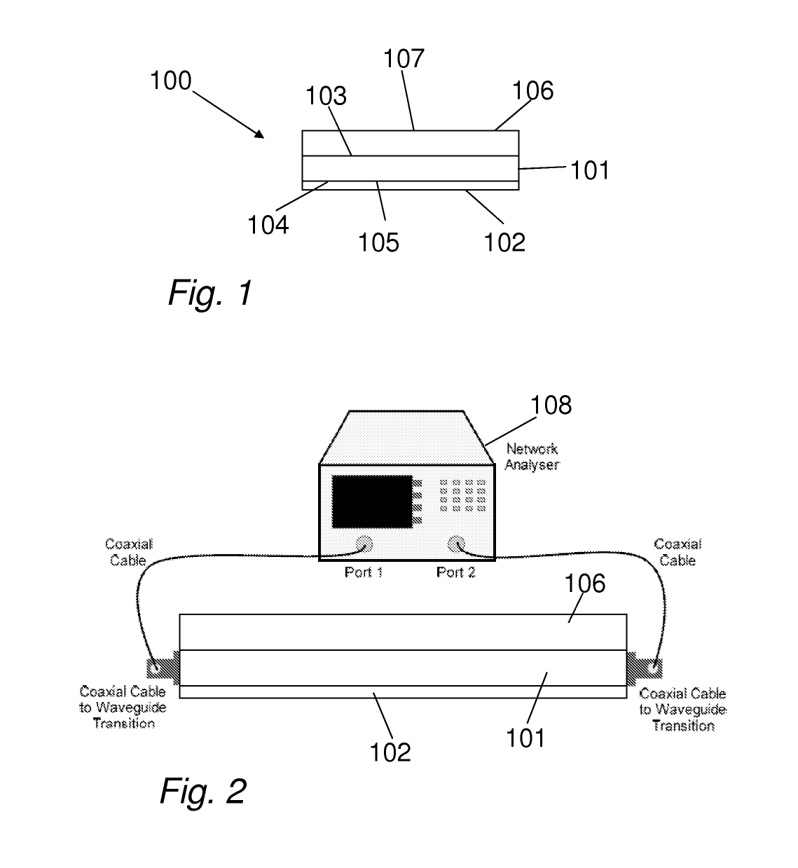

A first embodiment of the invention will be described in connection with FIG. 1. FIG. 1 shows an elongate guiding medium 100 which includes a dielectric layer 101 and a conductive layer 102. This guiding medium may be similar to the one described in the applicant's co-pending patent application published under number GB2,494,435A. The dielectric layer 101 may take the form of a sheet of material having a uniform thickness. The width and length of the dielectric layer 101 may vary depending on the specific application. An upper surface 103 of the dielectric layer 101 is the surface over which surface waves are transmitted, as will be described in more detail below. The conductive layer 102 may also take the form of a sheet of material having a uniform thickness. The width and length of the conductive layer 102 are generally the same as those equivalent dimensions of the dielectric layer 101. However, as will be seen below, it may be advantageous for the conductive layer 102 to have different dimensions to the dielectric layer in some circumstances. An upper surface 104 of the conductive layer 102 is positioned against a lower surface 105 of the dielectric layer 101. The dielectric layer 101 and the conductive layer 102 accordingly form a dielectric coated conductor.

The upper surface 103 of the dielectric layer 101 has a reactive impedance which is greater than its resistive impedance. Such a surface is suitable for guiding surface waves. In particular, the reactance and resistance is such that the surface is suitable for guiding Zenneck surface waves.

The guiding medium 100 also includes a protective layer 106, which is positioned over the dielectric layer 101. The width and length of the protective layer 106 are generally the same as those equivalent dimensions of the dielectric layer 101. The protective layer 106 has an upper surface 107 which is shown at the top of the arrangement shown in FIG. 1. The protective layer 106 also has a lower surface which is arranged to be in contact with the upper surface 103 of the dielectric layer 101.

The protective layer 106 provides numerous advantages. In the absence of a protective layer, an object may be placed on a guiding medium such that the object completely blocks the channel formed by the guiding medium. Any surface waves travelling along the guiding medium will be completely blocked. The protective layer 106 allows the surface wave to continue along the guiding medium 100, even when an object is placed over the guiding medium. This is the case even when the protective layer is very thin.

It will be appreciated that whilst the protective layer 106 provides the above advantages, its presence restricts how close a wave coupling node can be positioned to the dielectric medium. Wave coupling nodes are devices for coupling surface waves onto and off the surface of the guiding medium 100, and are also known as surface wave launchers, surface wave probes or wave probe. Wave coupling nodes may be similar to those described in the applicant's co-pending patent application published under number GB2,494,435A. Wave coupling nodes may couple only a portion of the wave energy of a surface wave from guiding medium, allowing a surface wave to be both received at the wave coupling node and to continue along the medium upon which it was travelling so that, for example, other wave coupling nodes can couple a portion of the same surface wave off of the same guiding medium.

A series of measurements were carried out to investigate how varying the thickness of the protection layer 106 would alter the loss produced by a blockage. The protection layer used for the test was formed of foam plastic. FIG. 2 shows the experimental setup for performing measurements on the guiding medium. A network analyser 108 was connected via coaxial cable to the guiding medium 100. It was found that in some embodiments, in order to achieve protection from objects coming into contact with the guiding medium whilst minimizing the loss associated with displacing the wave coupling node away from the surface of the dielectric layer 101, the preferred thickness of the protection layer 106 was equal to between 0.5 and 2 times the wavelength of the surface wave being transmitted along the guiding medium 100. For example, at 60 GHz, a thickness of between 2.5 mm and 10 mm may be preferable and at 45 GHz a thickness of between about 3.5 mm and 13 mm may be preferable. Additionally, it was found that having a protection layer 106 thickness of between 1 and 1.5 times the wavelength of the surface waves been transmitted provided a more preferable result in terms of minimising loss associated with wave coupling node height above the guiding medium 100 and objects coming into proximity of the guiding medium 100. Finally, it was found that a thickness of 1.3 times the wavelength of the surface waves being transmitted was most preferable. So at 60 GHz, a thickness of 6.5 mm may be desirable.

In other embodiments, the protective layer 106 may be thinner than 2 mm whilst still providing some protection to blockages but primarily minimising losses associated with wave coupling nodes being positioned at a distance above the dielectric layer 101. For example, the protective layer 106 could be in the order of 0.5 mm thick.

The protective layer 106 preferably has a low relative dielectric constant. In some embodiments, the relative dielectric constant is as close to one as possible, and preferably less than two. Examples of suitable materials include plastic foam materials such as expanded polystyrene, polyurethane and polythene. The protective layer 106 may be a solid, but may be formed from a structure which includes air gaps, such as a honeycomb. The advantage of this is that air has a low relative dielectric constant. The protective layer 106 effectively provides spacing above the dielectric layer 101, so that obstacles can never completely block the propagation path.

In some embodiments, the protection layer 106 may be made from a compressible material. Such a material may compress by a predetermined amount depending on the force applied and the area to which that force is applied. For example, pressure applied by objects having a relatively small surface area, such as a surface wave launcher, may cause substantial local compression of the protection layer 106, objects having a large surface area may cause relatively little or no compression of the layer 106 when pressed against the surface. Accordingly, the protection layer may maintain its thickness for the purposes of protecting the guiding medium from interruption whilst allowing probes to be placed closer to the surface of the guiding medium so as to minimise loss associated with the presence of the protection layer 106.

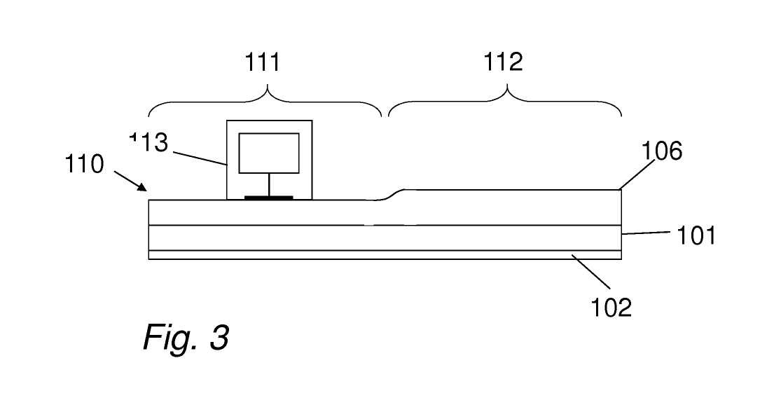

In addition to or as an alternative to providing a compressible protective layer, the protective layer 106 may be of a reduced thickness in areas in which surface wave launchers are to be positioned or are likely to be positioned. FIG. 3 shows an example guiding medium 110 similar to the guiding medium 100 shown in FIG. 1. In FIG. 3 the protective layer 106 has a reduced thickness area 111 and a standard thickness area 112. The reduced thickness area may be referred to as a minor region, and the standard thickness area may be referred to as a major region. A surface wave launcher may be positioned on the protective layer 106 in the reduced thickness area 111. The resultant system may provide optimum protection to obstacles in the area 112 of greater thickness whilst improving the coupling efficiency of a surface wave launcher in the reduced thickness area 111. The thickness of the reduced thickness area 111 may be in the region of 0.5 to 1 times the wavelength of the surface wave being transmitted and the thickness of the standard thickness area 112 may be in the region of 1.5 to 2 times the wavelength of the transmitted surface waves.

From experiments, it was also confirmed that transmission loss increases with the height of a surface wave launcher above the surface of the dielectric layer 101. To reduce loss associated with probe height, a monopole coupling probe could be used. The monopole would puncture the surface of the protective layer. Whilst the bandwidth provided by a monopole coupling probe would be reduced compared with an aperture coupling probe, at 60 GHz the reduction in loss would likely out way this reduction in bandwidth.

As well as providing electrical protection, the protective layer 106 provides physical protection. Any scuffing or other minor physical damage will occur to the protective layer 106, rather than occurring to the dielectric layer 101. The protective layer 106 will also reduce the specific absorption rate (SAR) of any person touching the guiding medium 100.

In the context of the present application, an impedance layer is a layer having a specific impedance. In the present case, the surface impedance is suitable for the propagation of electromagnetic surface waves. Examples of suitable impedance layers includes (but are not limited to): dielectric coated conductors, dialectic slabs, PCBs with a Sievenpiper surface, corrugations, corrugations with dielectric filled grooves and other “periodic structures”, whether they be metallic, dielectric or combination of both.

Features of the present invention are defined in the appended claims. While particular combinations of features have been presented in the claims, it will be appreciated that other combinations, such as those provided above, may be used.

Further modifications and variations of the aforementioned systems and methods may be implemented within the scope of the appended claims.

1. A guiding medium for guiding radio frequency (RF) electromagnetic surface waves, comprising:
a first surface, the first surface having a surface impedance suitable for propagation of RF electromagnetic surface waves; and
a protection layer positioned on or adjacent the first surface.

2. A guiding medium according to claim 1, wherein the protection layer has a relative dielectric constant of less than 2.

3. A guiding medium according to claim 2, wherein the protection layer has a relative dielectric constant of less than 1.1.

4. A guiding medium according to claim 1, wherein the protection layer is made of a solid material or of a honeycomb.

5. A guiding medium according to claim 1, wherein the protection layer is between 2.5 and 10 mm thick.

6. A guiding medium according to claim 1, wherein the protection layer is between 5 mm and 7 mm thick.

7. A guiding medium according to claim 1, arranged to sustain RF electromagnetic surface waves having a predetermined wavelength or range of wavelengths, wherein the protection layer has a thickness of between 0.5 and 2 times the predetermined wavelength or range of wavelengths.

8. A guiding medium according to claim 1, wherein guiding medium has the surface impedance of greater than 50 Ohms.

9. A guiding medium according to claim 8, wherein the guiding medium has the surface impedance of between 100 and 300 Ohms.

10. A guiding medium according to claim 1, further comprising an impedance layer, wherein a first surface of the impedance layer is said first surface of the guiding medium.

11. A guiding medium according to claim 10, wherein said impedance layer comprises a dielectric layer, and said first surface of the impedance layer is a first surface of the dielectric layer.

12. A guiding medium according to claim 10, wherein said impedance layer is a periodic structure which artificially increases surface impedance.

13. A guiding medium according to claim 1, wherein the guiding medium is configured to guide RF electromagnetic surface waves having a frequency of between 20 and 100 GHz.

14. A guiding medium according to claim 1, wherein the protection layer comprises a major region and a minor region, the minor region having a thickness less than that of the major region, and the minor region being configured to receive a surface wave coupling node thereon.

15. A guiding medium according to claim 1, wherein the protective layer is made from a compressible material and/or wherein the protection layer is made of a plastic foam.

16. A guiding medium according to claim 1, wherein the guiding medium is an elongate surface wave channel.

17. A system for transmission of RF electromagnetic surface waves, the system comprising:
a guiding medium comprising a first surface, the first surface having an electrical impedance suitable for propagation of the RF electromagnetic surface waves, and a protection layer positioned on or adjacent the first surface; and
at least one wave coupling node, the wave coupling node having a transmitter and/or receiver coupled to a transducer, the transducer positioned on or adjacent to a surface of the protection layer distal the first surface of the guiding medium; wherein
the at least one wave coupling node is arranged to launch and/or receive surface waves over the first surface of said guiding medium.

18. A guiding medium according to claim 1, wherein the guiding medium is made of a textile material.
